(19) United States
(12) Patent Application Publication
(10) Pub. No.: US 2024/0370288 A1
(43) Pub. Date: Nov. 7, 2024

(54) DYNAMIC REASSIGNMENT OF HARDWARE ACCESS TO VIRTUALIZED SYSTEMS IN 5G NETWORKS

(71) Applicant: DISH Wireless L.L.C., Englewood, CO (US)

(72) Inventor: Christopher Scherrer, Englewood, CO (US)

(73) Assignee: DISH Wireless L.L.C., Englewood, CO (US)

(21) Appl. No.: 18/312,494

(22) Filed: May 4, 2023

(51) Int. Cl. G06F 9/455

(52) U.S. Cl. CPC G06F 9/45558; G06F 2009/4557; G06F 2009/45595

(57) ABSTRACT

Systems, processes, and devices migrate virtual machines to new servers. An example process includes identifying a virtual machine for migration in response to a load on a host server running the virtual machine. A direct device assignment of the virtual machine may be detected. The virtual machine may communicate with a first hardware device of the host server using the direct device assignment to bypass a host operating system of the host server. A target server is identified, and a replacement device assignment is reserved on the target server. The replacement device assignment includes a link to a second hardware device of the target server configured to bypass a host operating system of the target server. The virtual machine running on the host server is reconfigured with data supporting the replacement device assignment on the target server. The virtual machine migrates to the target server.

### TECHNICAL FIELD

The following discussion generally relates to virtualization, and in particular to dynamically reassigning hardware access to virtualized network functions in 5G networks.

### BACKGROUND

Wireless networks that transport digital data and telephone calls are becoming increasingly sophisticated. Currently, fifth generation (“5G”) broadband cellular networks are being deployed around the world. These 5G networks use emerging technologies to support data and voice communications with millions, if not billions, of mobile phones, computers, and other devices. 5G technologies are capable of supplying much greater bandwidths than were previously available, so it is likely that the widespread deployment of 5G networks could radically expand the number of services available to customers. This expansion will accompany an increased need for flexibility of network functions.

The growing bandwidth and capacity of data and telephone networks relies on increasing software and hardware resources to support such networks. Hardware radio units and antennas are typically fixed in permanent or semi-permanent locations. In order to expand the area served by radio units, more units can be deployed, or existing units can be redeployed. Either way, hardware must be physically present in the desired location.

The same is true for cloud-based hardware that runs virtualized 5G infrastructure. The number of and location of computing resources can impact network performance. Commissioning and decommissioning virtualized assets can result in reassignment or reallocation of resources to balance load across hardware. Some resource allocation may be hard coded into the virtualization infrastructure, which can restrict the ability to reassign resources between virtualized machines. For example, Single Root I/O Virtualization (SR-IOV) allows a PCIe device to separate access to its resources and bypass a layer of virtualization for improved performance. However, SR-IOV can limit the ability to migrate a virtualized machine to another computing resource.

### SUMMARY

Systems, methods, and devices migrate virtual machines to new servers. An example process includes identifying a virtual machine for migration in response to a load on a host server running the virtual machine. A direct device assignment of the virtual machine may be detected. The virtual machine may communicate with a first hardware device of the host server using the direct device assignment to bypass a host operating system of the host server. A target server is identified, and a replacement device assignment is reserved on the target server. The replacement device assignment includes a link to a second hardware device of the target server configured to bypass a host operating system of the target server. The virtual machine running on the host server is reconfigured with data supporting the replacement device assignment on the target server. The virtual machine migrates to the target server.

In various embodiments, the virtual machine runs a distributed unit or a central unit of a 5G data and telephone network. The virtual machine may run a network function of a 5G data and telephone network, and the network function may include an application function (AF), an access and mobility management function (AMMF), an authentication server function (AUSF), a network function local repository (NRF), a packet forwarding control protocol (PFCP), a session management function (SMF), a unified data management (UDM), a unified data repository (UDR), or a user plane function (UPF). The replacement device assignment is reserved on the target server further by commissioning a dummy virtual machine on the target server. The dummy virtual machine is configured with the replacement device assignment. Migrating the virtual machine to the target server may further include commissioning the virtual machine having the replacement device assignment on the target server. The dummy virtual machine having the replacement device assignment may be decommissioned on the target server. A communication addressed to the direct device assignment may be forwarded from the host server to the replacement device assignment on the target server. The virtual machine automatically communicates with the second hardware device of the target server using the replacement device assignment in response to the virtual machine migrating to the target server.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the illustrations.

FIG. 1 illustrates an example of a 5G data and telephone network that uses virtualized network functions, in accordance with various embodiments.

FIG. 2 illustrates an example virtualization system that migrates virtual machines between servers, in accordance with various embodiments.

FIG. 3 illustrates an example process for migrating virtual machines between servers, in accordance with various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

Systems, methods, and devices of the present disclosure enable concurrent use of virtual machine transfer technologies such as vMotion, for example, with resource assignment technologies such as Single Root I/O Virtualization (SR-IOV), for example. Migration of virtual machines to different servers while using resource assignment tools typically requires a restart. However, the techniques described herein enable migration between servers without rebooting a system.

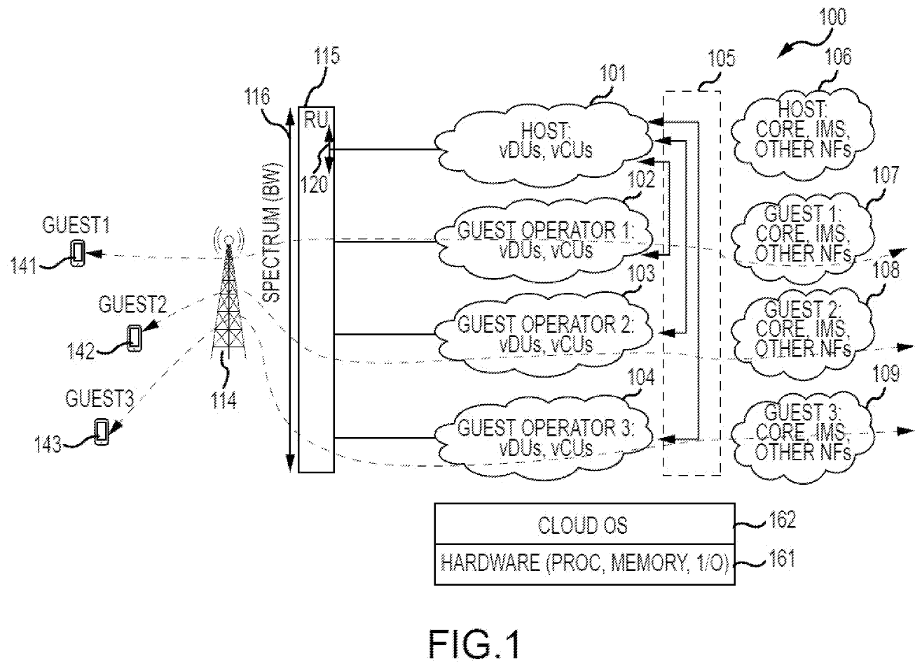

With reference now to FIG. 1, an example of a 5G data and telephone network 100 built on a cloud-based environment is shown, in accordance with various embodiments. 5G data and telephone network 100 is implemented on cloud-based infrastructure to facilitate dynamic network adaptations. 5G data and telephone network 100 includes a host operator maintaining ownership of one or more radio units (RUs) 115 associated with a wireless network cell. The example of FIG. 1 depicts a host operator operating a “radio/spectrum as a service (R/SaaS)” that allocates bandwidth on its own RUs for use by one or more guest network operators, though the systems, methods, and devices described herein could be applied to any wireless network using virtualized network functions. Examples of guest network operators may include internal brands of the host operator, system integrators, enterprises, external MVNOs, or converged operators. The host and the guest network operators may maintain desired network functions to support user equipment (UE) 141, 142, 143.

The host and MVNOs may have their own user accounts and virtualized network functions to support operation of 5G data and telephone network 100. User accounts may be provisioned and deprovisioned frequently as virtualized assets come online and go offline to support increasing or decreasing demand for network functions.

In the example of FIG. 1, cach RU 115 communicates with UE 141, 142, 143 operating within a geographic area using one or more antennas 114 (also referred to herein as towers) capable of transmitting and receiving messages within an assigned spectrum 116 of electromagnetic bandwidth. In various embodiments, guest networks 102, 103, 104 interact with a provisioning plane 105 to obtain desired spectrum across one or more of the RUs 115 operated by the host network 101. Provisioning plane 105 allows guest network operators to obtain or change their assigned bandwidths on different RUs 115 on an on-demand and dynamic basis. Network services 107, 108, 109 may be maintained by guest operators and network services 106 may be maintained by host network 101. Network services may be scaled up and down in response to network load, with resource reassignment occurring in real-time.

The Open Radio Access Network (O-RAN) standard breaks communications into three main domains: the radio unit (RU) that handles radio frequency (RF) and lower physical layer functions of the radio protocol stack, including beamforming; the distributed unit (DU) that handles higher physical access layer, media access (MAC) layer, and radio link control (RLC) functions; and the centralized unit (CU) that performs higher level functions, including quality of service (QoS) routing and the like. The CU also supports packet data convergence protocol (PDCP), service data adaptation protocol (SDAP), and radio resource controller (RRC) functions. The RU, DU, and CU functions are described in more detail in the O-RAN standards, as updated from time to time, and may be modified as desired to implement the various functions and features described herein. In the example of FIG. 1, host network 101 maintains one or more DUs and CUs (i.e., network functions) as part of its own network that can host core network functions. Examples of 5G core network functions suitable for virtualization and logging as described herein may include Application Function (AF), Access and Mobility Management Function (AMMF), Authentication Server Function (AUSF), Network Function Local Repository (NRF), Packet Forwarding Control Protocol (PFCP), Session Management Function (SMF), Unified Data Management (UDM), Unified Data Repository (UDR), or User Plane Function (UPF). The DU communicates with one or more RUs 115, as specified in the O-RAN standard. The virtualized DUs and CUs can communicate on virtualized network ports. The virtualized network ports can be dynamically reassigned using techniques described below.

The various network components shown in FIG. 1 are typically implemented using software or firmware instructions that are stored in a non-transitory data storage (e.g., a disk drive, solid-state memory, or other storage medium) for execution by one or more processors. The various components shown in FIG. 1 can be implemented using cloud computing hardware 161 and an appropriate operating system 162, such as the Amazon® Web Service (AWS) platform offered by Amazon Inc., although other embodiments could use other cloud platforms or any type of conventional physical computing hardware, as desired.

As illustrated in the example of FIG. 1, 5G data and telephone network 100 includes a host network 101 and one or more guest networks 102, 103, 104. The host network 101 is typically operated by an organization that owns radio equipment and sufficient spectrum (potentially on different bands) to offer 5G capacity and coverage. Host network 101 provides 5G services to connected UEs, and it manages network services available to its own UEs or those of its guest operators. Host network 101 includes at least one DU and at least one CU, both of which may be implemented as virtualized computing units using cloud resources.

Guest networks 102, 103, 104 operated by guest operators can manage their own networks using allocated portions of spectrum 116 handled by one or more of the RUs 115 associated with host network 101. The guest networks 102, 103, 104 communicate with one or more UEs 141-143 using allocated bandwidth on the host's RU 115. Guest networks 102, 103, 104 may include one or more virtual DUs and CUs, as well as other network services 107, 108, 109. Generally, one or more guest operators will instantiate their own 5G virtualized network functions (e.g., CMS, vCUs, vDUs, etc.) using cloud-based resources, as noted above. However, various embodiments could operate wholly or partially outside of cloud-based environments. Some embodiments may be implemented at private data centers using virtualization hardware such as, for example, a hypervisor managing virtualization on a server.

Each RU 115 is typically associated with a different wireless cell that provides wireless data communications to user equipment 141-143. RUs 115 may be implemented with radios, filters, amplifiers, and other telecommunications hardware to transmit digital data streams via one or more antennas 114. Generally, RU hardware includes one or more processors, non-transitory data storage (e.g., a hard drive or solid-state memory), and appropriate interfaces to perform the various functions described herein. RUs are physically located on-site with antenna 114. Conventional 5G networks may make use of any number of wireless cells spread across any geographic area, cach with its own on-site RU 115.

RUs 115 support wireless communications with any number of user equipment 141-143. UE 141-143 are often mobile phones or other portable devices that can move between different cells associated with the different RUs 115, although 5G networks are also widely expected to support home and office computing, industrial computing, robotics, Internet-of-Things (IoT), and many other devices. While the example illustrated in FIG. 1 shows one RU 115 for convenience, a practical implementation will typically have any number of virtualized RUs 115 that provide highly configurable geographic coverage for a host or guest network, if desired.

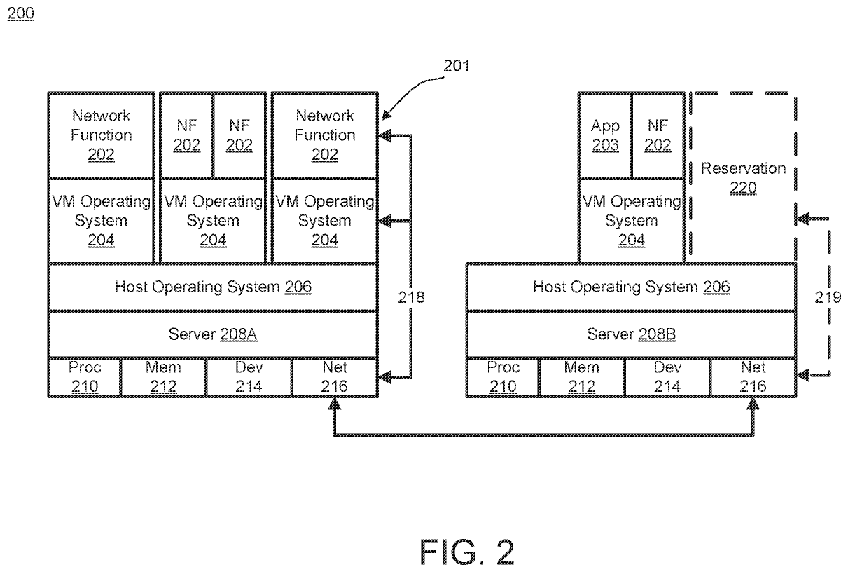

Referring now to FIG. 2, an example system 200 is shown with virtualized network functions 202. System 200 includes servers 208A, 208B with various types of hardware. Server 208 includes a processor 210 in communication with non-transitory memory 212 configured to store instructions for execution by the processor. The processor and memory may be in communication with device 214 and network interface 216. Device 214 can include network adapters, PCIe devices, serial devices, USB devices, network adapters, or other hardware accessible by server 208. Network interface 216 may include a network card, ethernet adapter, wireless transceiver, ethernet modem, or other device capable of communicating on a local area network (LAN) or wide area network (WAN). Device 214 or network interface 216 support externally routed communications into and out of server 208.

In various embodiments, server 208 runs host operating system 206 to support virtualization. Examples of host operating system 206 can include a Hyper-V, VMWare, Kubernetes, Xen, Docker, or other types of virtualization software. Host operating system 206 can also include an underlying operating system such as Windows, Linux, iOS, or other server-level operating systems that then run virtualization software. Each virtual machine 201 (VM) includes a VM operating system 204 that runs network functions 202 or applications 203. VMs 201 run on host operating systems 206. Link 218 may give network function 202 or VM operating system 204 direct access to device 214 or network interface 216. Link 218 may bypass host OS 206 and some resources of server 208 to establish a direct connection to network interface 216. For example, link 218 may be an SR-IOV connection. Link 218 may comprise a logical port assigned to virtual machine 201. Link 218 can give the linked virtual machine 201 near-native performance and full access to communicate on network interface 216. Link 218 may also be referred to as a direct device assignment.

In various embodiments, load balancing can involve moving VMs 201 from one server 208 to another. Link 218 may break if a virtual machine 201 is moved from one server 208 to another because link 218 bypasses layers that might facilitate such a transfer in some embodiments (e.g., Host OS 206). For example, host OS 206 can include load balancing tools such as vMotion. Such load balancing tools and resource assignment tools, such as SR-IOV, are typically incompatible. The techniques described herein may be used to move virtual machines 201 and their applications 203 or network functions 202 from server 208A to server 208B while maintaining network access previously serviced through link 218.

In some embodiments, server 208B may have available capacity to run a virtual machine 201. A load balancer or migration controller may contact server 208B and obtain reservation 220 of resources suitable for migrating a virtual machine 201 from server 208A to server 208B. The reservation may include link 219 that will bypass host operating system 206 to communicate using network interface 216. Link 219 may be similar to or the same as link 218. Virtual machine 201 may be reconfigured to use link 219 instead of link 218 before migrating from server 208A to server 208B.

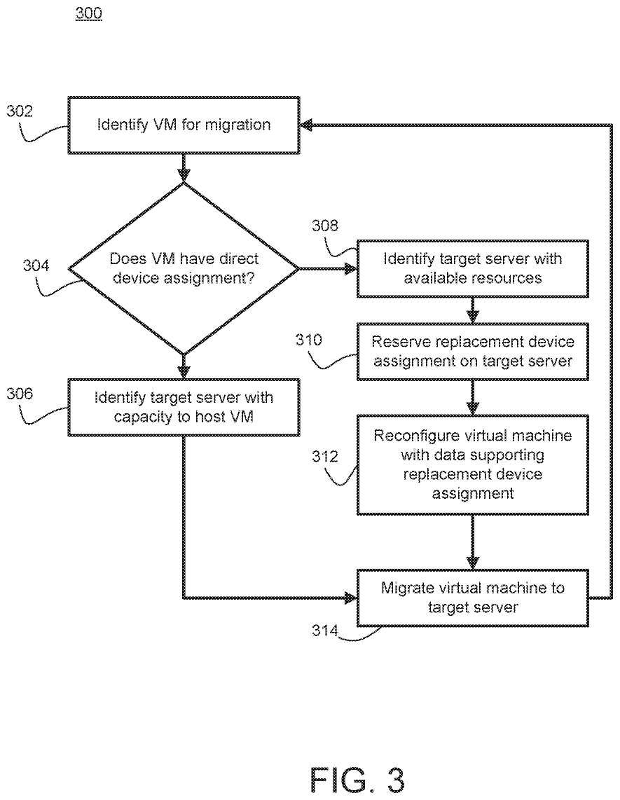

Referring now to FIG. 3, an example process 300 is shown for migrating virtual machines 201 (of FIG. 2) to a new server 208 (of FIG. 2), in accordance with various embodiments. Process 300 can thus be used to manage underlying hardware load when running network functions 202 (of FIG. 2) or applications 203 (of FIG. 2) in 5G data and telephone network 100 (of FIG. 1). In the example of FIG. 3, a load balancer running on server 208A identifies a virtual machine 201 for migration (Block 302). Some embodiments could identify individual instances of network function 202 or applications 203 for migration. The load balancer may be incorporated into virtualization software of the host OS 206 in some embodiments. Other embodiments could run a load balancer external to server 208 to monitor and adjust load between a group of servers 208. Load balancers are used as an example, though other migration tools that move virtual machines, containers, or other instances of network functions could be used to perform migrations described herein.

In various embodiments, the load balancer running on server 208A checks whether the identified virtual machine 201 has a direct device assignment (Block 304). An example of a direct device assignment identifiable by server 208 may include an SR-IOV assignment of a virtualized port on network interface 216 (of FIG. 2). The direct device assignment (e.g., link 218 of FIG. 2) may enable virtual machine 201 to directly access network interface 216, bypassing all or part of host operating system 206 to send communications once the direct device assignment is established. If identified virtual machine 201 has no direct device assignment, then virtual machine 201 is migrated from server 208A to target server 208B (Block 306).

In response to detecting virtual machine 201 has a direct device assignment, various embodiments of a load balancer may identify a target server 208B with available resources to run virtual machine 201 (Block 308). A target server 208B may have available resources if it has resources to support a direct device assignment for the same type of device that virtual machine 201 is using with a direct device assignment on server 208A. For example, server 208B may be identified as a target server in response to having capacity on network interface 216 to replace link 218 of the selected virtual machine 201. Server 208B may also be identified as a target server in response to having available computing, memory, storage, or other resources. Server 208B may also be identified as a target server in response to having lower resource usage than server 208A by a predetermined amount. For example, server 208B may be identified as a target server in response to having processor load under 50%, memory usage under 80%, and an available virtualized port on network interface 216 for assignment.

In various embodiments, the load balancer reserves resources for the selected virtual machine 201 (Block 310). The reservation may include server 208B commissioning or creating a dummy virtual machine as a placeholder and assigning the reserved resources to the dummy virtual machine, then decommissioning the dummy virtual machine in response to commissioning the migrated virtual machine 201. The reservation may also include the target server 208 removing the direct device assignment that will support the migrated virtual machine 201 from a pool of available resources. For example, server 208B may reserve port 1 of 8 for use by a virtual machine to be migrated to server 208B by creating dummy link 219. Dummy link 219 marks the port as in use on server 208B. Dummy link 219 may be assigned to a dummy virtual machine or placeholder to create a reservation for selected virtual machine 201 migrating from server 208A.

System 200 may reconfigure selected virtual machine 201 with the replacement device assignment (Block 312). Server 208A may change the direct device assignment on server 208A by replacing it with the replacement device assignment on server 208B. For example, server 208A may update data establishing link 218 on server 208A with data establishing link 219 on server 208B. Link 219 may be inactive until VM 201 is migrated to server 208B. Communications sent to or from virtual machine 201 may be stored or forwarded after data establishing link 219 replaces data establishing link 218 and before the migration to server 208B is complete. Communications addressed to link 218 may be forwarded from server 208A to server 208B for delivery on link 219. Communications may be delivered to VM 201 on server 208A using an intermediate application that listens on link 218 and delivers communications to VM operating system 204 or network function 202 running on VM 201. Link 218 may be maintained to capture communications until migration of VM 201 is complete. VM 201 may be momentarily operating with slower communications due to intermediate steps taken to preserve communications after port reassignment and before completing the migration.

In various embodiments, virtual machine 201 is migrated from server 208A to server 208B (Block 314). Migration may be completed when VM 201 is up and running in place of reservation 220. Link 219 is operational with virtual machine 201 running on server 208B communicating on link 219 and bypassing all or part of host operating system 206. Migration may include releasing old resources on server 208A after moving virtual machine 201 to server 208B. For example, server 208A may release the virtual network port supporting link 218 in response to decommissioning VM 201 on server 208A. Migration of VM 201 is typically complete in a matter of seconds. In some embodiments, the entire migration process including resource reassignment may be completed in less than a second, less than two seconds, less than three seconds, less than four seconds, or less than five seconds. Virtual machine 201 migrated to server 208B may automatically communicate on the replacement device assignment in response to running on server 208B.

Systems, methods, and devices of the present disclosure migrate virtual machines to new hardware while maintaining direct device assignments. In examples using tools such as SR-IOV and vMotion, connections to virtualized network ports or other PCIe devices can be seamlessly reestablished on new hardware. Migrations with direct device connections are completed in a matter of seconds without completely rebooting servers 208 or virtual machines 201.

Benefits, other advantages, and solutions to problems have been described herein with regard to specific embodiments. Furthermore, the connecting lines shown in the various figures contained herein are intended to represent exemplary functional relationships or couplings between the various elements. It should be noted that many alternative or additional functional relationships or connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used herein, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of clements does not include only those elements but may include other elements not expressly listed or inherent to such process, method, article, or device.

The term “exemplary” is used herein to represent one example, instance, or illustration that may have any number of alternates. Any implementation described herein as “exemplary” should not necessarily be construed as preferred or advantageous over other implementations. While several exemplary embodiments have been presented in the foregoing detailed description. it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A method of migrating a virtual machine, comprising:
identifying the virtual machine for migration in response to a load on a host server running the virtual machine;
detecting a direct device assignment of the virtual machine, wherein the virtual machine communicates with a first hardware device of the host server using the direct device assignment to bypass a first host operating system of the host server;
identifying a target server with available resources to run the virtual machine;
reserving a replacement device assignment on the target server, wherein the replacement device assignment comprises a link to a second hardware device of the target server configured to bypass a second host operating system of the target server;
reconfiguring the virtual machine running on the host server with data supporting the replacement device assignment on the target server, wherein the replacement device assignment replaces the direct device assignment; and
migrating the virtual machine to the target server.

2. The method of claim 1, wherein the virtual machine runs a distributed unit or a central unit of a 5G data and telephone network.

3. The method of claim 1, wherein the virtual machine runs a network function of a 5G data and telephone network, the network function comprising an application function (AF), an access and mobility management function (AMMF), an authentication server function (AUSF), a network function local repository (NRF), a packet forwarding control protocol (PFCP), a session management function (SMF), a unified data management (UDM), a unified data repository (UDR), or a user plane function (UPF).

4. The method of claim 1, wherein reserving the replacement device assignment on the target server further comprises commissioning a dummy virtual machine on the target server, wherein the dummy virtual machine is configured with the replacement device assignment.

5. The method of claim 4, wherein migrating the virtual machine to the target server further comprises:
commissioning the virtual machine having the replacement device assignment on the target server; and
decommissioning the dummy virtual machine having the replacement device assignment on the target server.

6. The method of claim 1, further comprising forwarding a communication addressed to the direct device assignment from the host server to the replacement device assignment on the target server.

7. The method of claim 1, wherein the virtual machine automatically communicates with the second hardware device of the target server using the replacement device assignment in response to migrating the virtual machine to the target server.

8. A virtualization system comprising a processor in communication with a non-transitory memory configured to store instructions that, when executed by the processor, cause the virtualization system to perform operations, the operations comprising:
identifying a virtual machine for migration in response to a load on a host server running the virtual machine;
detecting a direct device assignment of the virtual machine, wherein the virtual machine communicates with a first hardware device of the host server using the direct device assignment to bypass a first host operating system of the host server;
identifying a target server with available resources to run the virtual machine;
reserving a replacement device assignment on the target server, wherein the replacement device assignment comprises a link to a second hardware device of the target server configured to bypass a second host operating system of the target server;
reconfiguring the virtual machine running on the host server with data supporting the replacement device assignment on the target server, wherein the replacement device assignment replaces the direct device assignment; and
migrating the virtual machine to the target server.

9. The virtualization system of claim 8, wherein the virtual machine runs a distributed unit or a central unit of a 5G data and telephone network.

10. The virtualization system of claim 8, wherein the virtual machine runs a network function of a 5G data and telephone network, the network function comprising an application function (AF), an access and mobility management function (AMMF), an authentication server function (AUSF), a network function local repository (NRF), a packet forwarding control protocol (PFCP), a session management function (SMF), a unified data management (UDM), a unified data repository (UDR), or a user plane function (UPF).

11. The virtualization system of claim 8, wherein reserving the replacement device assignment on the target server further comprises commissioning a dummy virtual machine on the target server, wherein the dummy virtual machine is configured with the replacement device assignment.

12. The virtualization system of claim 11, wherein migrating the virtual machine to the target server further comprises:
commissioning the virtual machine having the replacement device assignment on the target server; and
decommissioning the dummy virtual machine having the replacement device assignment on the target server.

13. The virtualization system of claim 8, wherein the operations further comprise forwarding a communication addressed to the direct device assignment from the host server to the replacement device assignment on the target server.

14. A non-transitory computer-readable medium having instructions stored thereon that, when executed by a virtualization system, cause the virtualization system to perform operations, the operations comprising:
identifying a virtual machine for migration in response to a load on a host server running the virtual machine;
detecting a direct device assignment of the virtual machine, wherein the virtual machine communicates with a first hardware device of the host server using the direct device assignment to bypass a first host operating system of the host server;
identifying a target server with available resources to run the virtual machine;
reserving a replacement device assignment on the target server, wherein the replacement device assignment comprises a link to a second hardware device of the target server configured to bypass a second host operating system of the target server;
reconfiguring the virtual machine running on the host server with data supporting the replacement device assignment on the target server, wherein the replacement device assignment replaces the direct device assignment; and
migrating the virtual machine to the target server.

15. The non-transitory computer-readable medium of claim 14, wherein the virtual machine runs a distributed unit or a central unit of a 5G data and telephone network.

16. The non-transitory computer-readable medium of claim 14, wherein the virtual machine runs a network function of a 5G data and telephone network, the network function comprising an application function (AF), an access and mobility management function (AMMF), an authentication server function (AUSF), a network function local repository (NRF), a packet forwarding control protocol (PFCP), a session management function (SMF), a unified data management (UDM), a unified data repository (UDR), or a user plane function (UPF).

17. The non-transitory computer-readable medium of claim 14, wherein reserving the replacement device assignment on the target server further comprises commissioning a dummy virtual machine on the target server, wherein the dummy virtual machine is configured with the replacement device assignment.

18. The virtualization system of claim 17, wherein migrating the virtual machine to the target server further comprises:
commissioning the virtual machine having the replacement device assignment on the target server; and
decommissioning the dummy virtual machine having the replacement device assignment on the target server.

19. The non-transitory computer-readable medium of claim 14, wherein the operations further comprise forwarding a communication addressed to the direct device assignment from the host server to the replacement device assignment on the target server.

20. The non-transitory computer-readable medium of claim 14, wherein the virtual machine automatically communicates with the second hardware device of the target server using the replacement device assignment in response to migrating the virtual machine to the target server.
